(19) United States
(12) Patent Application Publication
(10) Pub. No.: US 2025/0306799 A1
(43) Pub. Date: Oct. 2, 2025

(54) LOW LATENCY SCRATCH MEMORY PATH

(71) Applicant: Advanced Micro Devices, Inc., Santa Clara, CA (US)

(72) Inventors: Nicolai Haehnle, Polling (DE); Mark Leather, Los Gatos, CA (US)

(21) Appl. No.: 18/619,513

(22) Filed: Mar. 28, 2024

(51) Int. Cl. G06F 3/06; G06F 9/30

(52) U.S. Cl. CPC G06F 3/0659; G06F 3/0611; G06F 3/0673; G06F 9/30036

(57) ABSTRACT

An apparatus and method for efficiently processing vector memory accesses on an integrated circuit. In various implementations, a computing system includes a processing circuit with multiple compute circuits for executing wavefronts of a parallel data application. Each compute circuit includes a local memory subsystem for accessing data not found in vector register files of the compute circuit. The local memory subsystem includes a first execution pipeline and a second execution pipeline. The second execution pipeline processes vector stack access instructions that access temporary data such as stack data of a function call used by each wavefront that is generated based on the function call. The first execution pipeline processes other types of vector memory access instructions and includes multiple complex pipeline stages not found in the second execution pipeline. Thus, the second execution pipeline has a latency less than the latency of the first execution pipeline.

### BACKGROUND

### Description of the Relevant Art

Highly parallel data applications are used in a variety of fields such as science, entertainment, finance, medical, engineering, social media, and so on. Machine learning data models, shader programs, and similar highly parallel data applications process large amounts of data by performing complex calculations at substantially high speeds. With an increased number of processing circuits in computing systems, the latency to deliver data to the processing circuits becomes emphasized. The performance, such as throughput, of the processing circuits depends on quick access to stored data. To support high-performance, the memory hierarchy includes storage elements with implementations that transition from relatively fast, volatile memory, such as registers on a processor die to caches either located on the processor die or connected to the processor die, and to off-chip storage with longer access times.

The benefit of the memory hierarchy reduces when access latencies increase. The access latency is measured from the point in time of instruction issue of the vector memory instruction until the point in time that targeted data is returned. Vector register files can be relatively large, but with vast amounts of data being retrieved from memory the data register files may not have sufficient space for the data. Consequently, data may be evicted from the register files to make room for different data. When this data is evicted, it is stored in a (vector) cache or other memory. Sending data to the vector cache in this manner is referred to as “spilling the data” to the vector cache and the corresponding data is referred to as “spilled data.” Subsequent accesses to the spilled data include using an execution pipeline of the local memory subsystem of the parallel data processing circuit. This execution pipeline includes multiple complex pipeline stages supporting per-lane address offsets, tag address coalescing, gather and scatter techniques, and so forth. Consequently, memory accesses targeting spilled data in the vector cache incur long latencies. Due to in-order processing of the vector memory instructions, the types of vector memory access instructions that do not require many of the techniques provided by the multiple complex pipeline stages incur unnecessary high latency.

In view of the above, efficient methods and mechanisms for efficiently processing vector memory accesses on an integrated circuit are desired.

### BRIEF DESCRIPTION OF THE DRAWINGS

FIG. 1 is a generalized diagram of a compute circuit that efficiently processing vector memory accesses on an integrated circuit.

FIG. 2 is a generalized diagram of a local memory subsystem that efficiently processing vector memory accesses on an integrated circuit.

FIG. 3 is a generalized diagram of an apparatus that efficiently processing vector memory accesses on an integrated circuit.

FIG. 4 is a generalized diagram of a computing system that efficiently processing vector memory accesses on an integrated circuit.

FIG. 5 is a generalized diagram of a method for efficiently processing vector memory accesses on an integrated circuit.

While the invention is susceptible to various modifications and alternative forms, specific implementations are shown by way of example in the drawings and are herein described in detail. It should be understood, however, that drawings and detailed description thereto are not intended to limit the invention to the particular form disclosed, but on the contrary, the invention is to cover all modifications, equivalents and alternatives falling within the scope of the present invention as defined by the appended claims.

### DETAILED DESCRIPTION

In the following description, numerous specific details are set forth to provide a thorough understanding of the present invention. However, one having ordinary skill in the art should recognize that the invention might be practiced without these specific details. In some instances, well-known circuits, structures, and techniques have not been shown in detail to avoid obscuring the present invention. Further, it will be appreciated that for simplicity and clarity of illustration, elements shown in the figures have not necessarily been drawn to scale. For example, the dimensions of some of the elements are exaggerated relative to other elements.

Apparatuses and methods efficiently processing vector memory accesses on an integrated circuit are contemplated. In various implementations, a computing system includes a processing circuit that is a parallel data processing circuit with a highly parallel data microarchitecture such as a single-instruction-multiple-data (SIMD) processor. The parallel data processing circuit includes multiple, replicated compute circuits, each with the circuitry of multiple lanes of execution. Each compute circuit executes one or more wavefronts. The parallel data processing circuit includes a memory used to store temporary data. An example of the temporary data is stack data (data stored in a stack) corresponding to a function call (e.g., used by each wavefront that is generated based on the function call). In some implementations, the stack data is stored in a memory that is a local memory of the parallel data processing circuit such as dedicated memory that is not shared with another processing circuit. In an implementation, the local memory is a portion of video memory used to store video frame data. In other implementations, the local memory is a local cache used to store the temporary data.

In various implementations, each compute circuit of a SIMD processor includes a dispatch circuit that includes a queue for storing multiple wavefronts before the wavefronts are dispatched for execution. Each SIMD circuit includes multiple lanes of execution for executing a wavefront. The compute circuit includes a local memory subsystem for accessing data not found in vector register files of the compute circuit. For example, in some cases data may have been “spilled” from the vector register files to a local memory in order to make room for other data. The local memory subsystem provides data for a variety of types of vector memory access instructions. An example of the vector memory access instructions is a texture sample instruction used to read texture pixel data from memory, sample or filter the retrieved texture pixel data, and store the results in a specified range of vector registers of the vector register file. Another example of the vector memory access instructions is an image load instruction used to read pixel data from memory and store the retrieved data in a specified range of vector registers of the vector register file without prior modification. Yet another example of vector memory access instructions is a vector stack access instruction that accesses temporary data. An example of the temporary data is stack data of a function call used by each wavefront that is generated based on the function call. Vector stack access instructions target data stored in the local memory using an address provided by the vector stack access instruction in place of using an address stored in the vector register file. Parallel data applications are using more and more high-level programming patterns that rely on function calls. Thus, the parallel data applications rely more and more on accessing stack data. The latencies of the vector stack access instructions determine the performance of the parallel data applications.

The local memory subsystem includes a first execution pipeline and a second execution pipeline where the second execution pipeline has a latency less than the latency of the first execution pipeline. Typically, the local memory subsystem includes a single execution pipeline with multiple complex pipeline stages that process vector memory access instructions in an in-order manner. The types of vector memory access instructions that do not require many of the complex pipeline stages provided by the single execution pipeline incur unnecessarily high latency. For example, vector stack access instructions do not require many of the complex pipeline stages. Rather than using a single execution pipeline, the local memory subsystem includes the first execution pipeline and the second execution pipeline where the second execution pipeline has a latency less than the latency of the first execution pipeline.

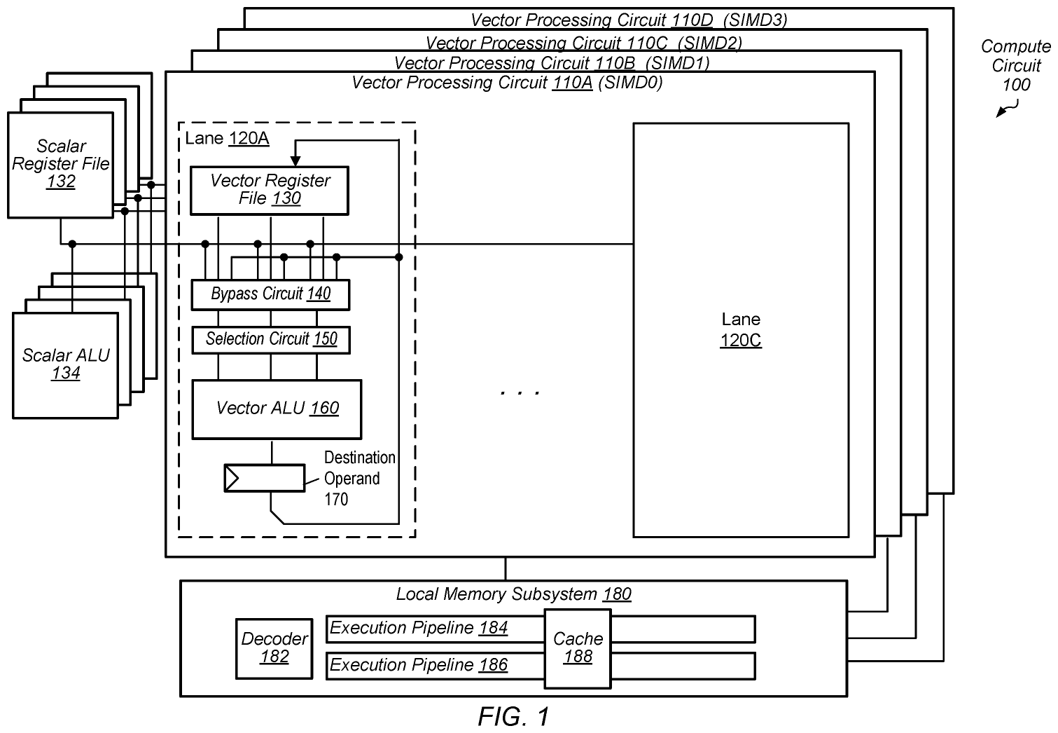

The first execution pipeline includes the multiple complex pipeline stages supporting per-lane address offsets, tag address coalescing, gather and scatter circuitry to handle different execution lanes of a same vector processing circuit accessing data items concurrently from different cache lines, post processing circuitry to handle sign extending data, converting data between data formats, performing texture sampling and/or filtering, and so forth. However, the second execution pipeline does not include these multiple complex pipeline stages for processing vector stack access instructions. Thus, the second execution pipeline has a latency less than the latency of the first execution pipeline. In various implementations, the first execution pipeline processes vector memory access instructions that are not vector stack access instructions, and the second execution pipeline processes vector stack access instructions. Therefore, the latencies of the vector stack access instructions greatly decrease, which improves the performance of parallel data applications relying on accesses of stack data. Further details of these techniques to efficiently process vector memory accesses on an integrated circuit are provided in the following description of FIGS. 1-5.

Turning now to FIG. 1, a generalized block diagram of compute circuit 100 that efficiently processes vector memory accesses on an integrated circuit is shown. In the illustrated implementation, compute circuit 100 includes the multiple vector processing circuits 110A-110D, each with multiple lanes 120A-120C. Each lane is also referred to as a single instruction multiple data (SIMD) lane. In various implementations, the hardware, such as circuitry, of each of vector processing circuits 110B-110D is an instantiation of the hardware of vector processing circuit 110A. Similarly, the hardware of lane 120C is an instantiation of the hardware of lane 120A. The components in lanes 120A-120C include circuit blocks that operate in lockstep. Although a particular number of vector processing circuits 110A-110D and lanes 120A-120C are shown, in other implementations, another number of these components are used based on design requirements. The lanes 120A-120C send vector memory access instructions to the local memory subsystem 180 for accessing data not found in the vector register file 130 of the lanes 120A-120C. The local memory subsystem 180 accesses local memory such as a local level-one (L1) data cache 185.

The parallel computational lanes 120A-120C operate in lockstep. In various implementations, the data flow within each of the lanes 120A-120C is pipelined. Pipeline registers are used for storing intermediate results. Within a given row across lanes 120A-120C, vector arithmetic logic unit (ALU) 150 includes the same circuitry and functionality, and operates on the same instruction, but different data associated with a different thread. A particular combination of the same instruction and a particular data item of multiple data items is referred to as a “work item.” A work item is also referred to as a thread. The multiple work items (or multiple threads) are grouped into thread groups, where a “thread group” is a partition of work executed in an atomic manner.

In some implementations, a thread group includes instructions of a function call that operates on multiple data items concurrently. Each data item is processed independently of other data items, but the same sequence of operations of the subroutine is used. As used herein, a “thread group” is also referred to as a “work block” or a “wavefront.” Tasks performed by compute circuit 100 can be grouped into a “workgroup” that includes multiple thread groups (or multiple wavefronts). The hardware, such as circuitry, of a scheduler schedules a workgroup to a compute circuit, such as compute circuit 100, and divides the workgroup into separate thread groups (or separate wavefronts) and assigns the thread groups to the vector processing circuits 110A-110D.

In an implementation, lane 120A includes vector register file 130 for storing operand data for vector operations. In one implementation, the lanes 120A-120C also share the scalar register file 332 that stores operands for scalar operations. In some implementations, compute circuit 100 also includes scalar ALU 334 that performs operations with operands fetched from scalar register file 332. Lanes 120A-120C receive a scalar data value from one or more of the scalar register file 332 and scalar ALU 334. Scalar data values are common to each work item in a wavefront. In other words, a scalar data operand is used by each of the lanes 120A-120C at the same time. In contrast, a vector data operand is a unique per work item value, so each of the lanes 120A-120C do not work on the same copy of the vector data operand. In one implementation, one or more instructions use vector data operands and generate a scalar result. Therefore, although not shown, the result data from destination operand 170 is also routed to scalar register file 332 in some implementations.

Bypass circuit 140 includes selection circuitry, such as multiplexers, or mux gates, for routing result data from destination operand 170 to selection circuit 342 without retrieving operand data from vector register file 130 or scalar register file 332. Therefore, the vector ALU 150 can begin operations sooner. Selection circuit 150 also includes multiplexers and possible crossbar circuitry to route source operands to particular inputs of operations being performed by vector ALU 150. In various implementations, lane 120A is organized as a multi-stage pipeline. Intermediate sequential elements, such as staging flip-flop circuits, registers, or latches, are not shown for ease of illustration.

Vector ALU 150 can include a variety of execution circuits. Although not shown, vector ALU 150 can include a variety of types of execution circuits such as a multiplier circuit, an adder circuit, a comparator circuit, a norm functional circuit, a rounding functional circuit, a clamping circuit, a divider circuit, a square root function circuit, and so forth. Vector ALU 150 can also include circuitry that supports a variety of mathematical operations such as integer mathematical operations, Boolean bit-wise operations, and floating-point mathematical operations. Although a single staging sequential element is shown for destination operand 170, in other implementations, lane 120A uses multiple stages of sequential elements to route the result data to bypass circuit 140, scalar register file 332, and vector register file 130.

As shown, each of the vector processing circuits 110A-110D uses data broadcasting and data forwarding via at least the bypass circuit 140 and the selection circuit 142. Vector processing circuits 110A-110D also support executing operations with a variety of data formats such as the 32-bit floating-point data format, the 16-bit bfloat16 data format, the 8-bit fixed-point int8 integer data format, the 4-bit fixed-point int4 integer data format, one of a variety of types of directional blocked data formats, one of a variety of types of scalar data formats, and so forth. These data formats provide a variety of precisions.

When executing a corresponding wavefront, a vector processing circuit of the vector processing circuits 110A-110D executes vector memory access instructions to access a corresponding data item for each of the lanes 120A-120C. For the vector memory access instructions targeting the local memory, the local memory subsystem 180 accesses one or more of a dedicated memory that is not shared with another processing circuit, a portion of video memory used to store video frame data, a local cache (e.g., cache 185), a dedicated scratchpad memory, or some other memory used as “scratch memory”. The local memory subsystem 180 services the vector memory access instructions targeting the local memory sent by the lanes 120A-120C.

The lanes 120A-120C send vector memory access instructions to the local memory subsystem 180 for accessing data not found in the vector register file 130 of the lanes 120A-120C. In contrast to a scalar memory access instruction targeting a single data value, the vector memory access instruction targets multiple, separate data items used to create work items for the lanes 120A-120C. The local memory subsystem 180 accesses local memory such as a local level-one (L1) data cache 185. Local memory subsystem 180 includes two independent execution pipelines 184 and 186. In various implementations, execution pipeline 186 has a latency less than the latency of the execution pipeline 184.

When decoder 182 generates an indication specifying a received vector memory access instruction is not a vector stack access instruction, decoder 182 sends the vector memory access instruction to execution pipeline 184. Otherwise, decoder 182 sends the vector memory access instruction to execution pipeline 186. A vector stack memory access instruction accesses temporary data. An example of the temporary data is stack data of a function call used by each wavefront that is generated based on the function call. For the vector memory access instructions sent by the multiple, replicated lanes 120A-120C targeting a local memory, local memory subsystem 180 accesses one or more of dedicated memory that is not shared with another processing circuit, a portion of video memory used to store video frame data, a local data cache, such as the local level-one (L1) data cache 188 used to store temporary data, a dedicated scratchpad memory, and so forth.

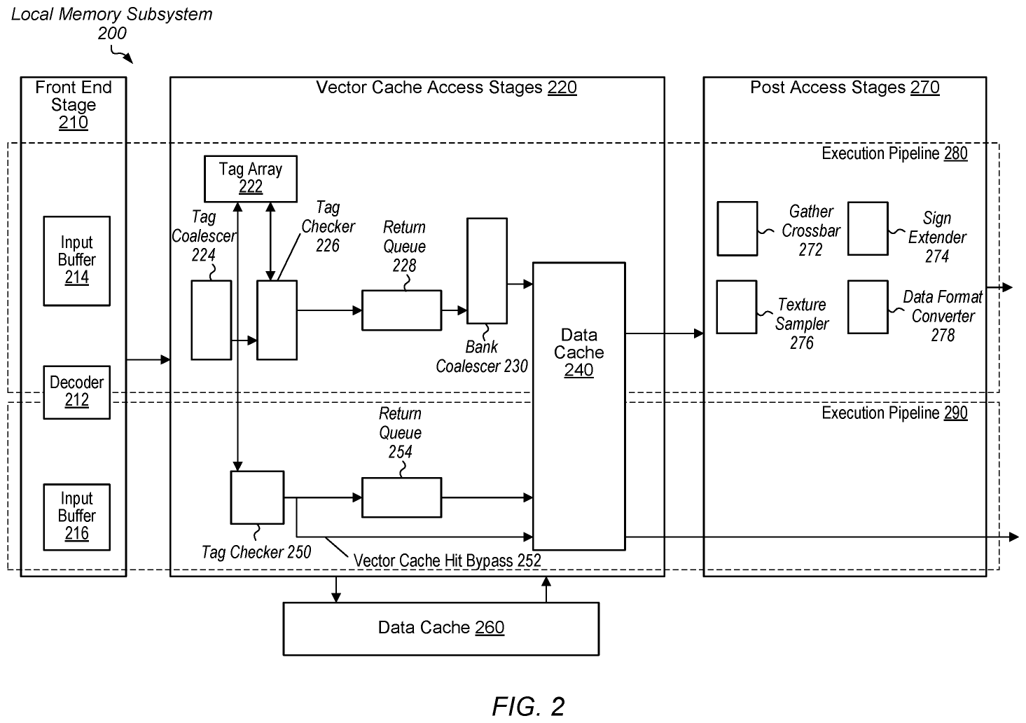

Execution pipeline 184 includes multiple complex pipeline stages supporting per-lane address offsets, tag address coalescing, gather and scatter circuitry to handle different execution lanes of a same vector processing circuit accessing data items concurrently from different cache lines, post processing circuitry to handle sign extending data, converting data between data formats, performing texture sampling and/or filtering, and so forth. Execution pipeline 186 does not include these multiple complex pipeline stages. Thus, execution pipeline 186 has a latency less than the latency of the execution pipeline 184. In various implementations, local memory subsystem 180 has the functionality of local memory subsystem 200 (of FIG. 2).

In one implementation, compute circuit 100 is used in a parallel data processing circuit such as a graphics processing unit (GPU), a digital signal processor (DSP), a field programmable gate array (FPGA), or otherwise. Parallel data processing circuits are efficient for data parallel computing found within loops of applications, such as in applications for computer and mobile device display graphics, molecular dynamics simulations, deep learning training, finance computations, and so forth. In some implementations, the functionality of compute circuit 100 is included as components on a single die, such as a single integrated circuit. In other implementations, the functionality of compute circuit 100 is included as multiple dies on a system-on-a-chip (SOC). In various implementations, compute circuit 100 is used in a desktop, a portable computer, a tablet computer, a smartwatch, a smartphone, or other.

Turning now to FIG. 2, a generalized diagram is shown of a local memory subsystem 200 that efficiently processes vector memory accesses on an integrated circuit. In various implementations, local memory subsystem 200 includes circuitry of a front-end stage 210, vector cache access stages 220, and post access stages 270. Local memory subsystem 200 also includes two execution pipelines (or paths) 280 and 290. Local memory subsystem 200 services vector memory access instructions targeting the local memory sent by multiple, replicated lanes of multiple vector processing circuits of a compute circuit. The compute circuit executes threads of a workgroup, and each of the vector processing circuits executes threads of a wavefront. For vector memory access instructions sent by the multiple lanes targeting a local memory, the local memory subsystem 200 accesses one or more of a dedicated memory that is not shared with another processing circuit, a portion of video memory used to store video frame data, a local data cache, such as the local level-one (L1) data cache 240 used to store temporary data, a dedicated scratchpad memory, and so forth. In various implementations, local memory subsystem 200 has the functionality of local memory subsystem 180 (of FIG. 1).

In an implementation, local memory subsystem 200 includes data cache 260 used as a level-two (L2) data cache. Each of the paths, execution pipeline 280 and 290, includes circuitry supporting vector memory accesses of a local memory such as a local level-one (L1) data cache 240. In various implementations, execution pipeline 290 has a lower access than the latency of the execution pipeline 280. Front-end stage 210 includes decoder 212 that receives vector memory access instructions and generates indications specifying the types of the vector memory access instructions. Decoder 212 uses the generated indications to select which of the two execution pipelines 280 and 290 to send the vector memory access instructions. For example, in various implementations the instruction set architecture may include separate instructions that can be used by a programmer to use either the first execution path 280 or the second execution path 290. In some cases, a compiler may generate an instruction for one of the paths based on explicitly provided programming by a programmer, or an instruction may be selected by a compiler based on a type of data being accessed or otherwise. For example, a compiler may generate instructions that spill data values from a register file to a cache. Having generated such instructions, the compiler uses a different instruction for accessing register values in subsequent code (program code to be executed subsequent to the spilling of the data values). Instead of using normal instructions to subsequently access such values, a new instruction(s) is used that uses path 290 (a new path). The new path bypasses the additional logic for accessing the register file and obtains the spilled data in a more direct manner. For example, addressing information of spilled data can be retrieved from a frame (stack). The retrieved addressing information can then be used to access the cache. In some implementations, the accessed data is stored in the register file where it is then accessed. In other implementations, the retrieved data is provided to the execution pipeline 290 directly (or other was forwarded to the pipeline 290). Various such implementations are possible and are contemplated.

The parallel data processing circuit that uses the multiple compute circuits supports execution of a variety of types of vector memory access instructions. Vector memory access instructions access multiple data items, each used for a respective work item of a wavefront. The wavefront is executed on a vector processing circuit (a SIMD circuit), and each lane of execution of the vector processing circuit within a corresponding compute circuit executes a respective thread or work item of the wavefront. Multiple wavefronts are assigned to multiple compute circuits, each with one or more vector processing circuits. At times, each work item of a wavefront accesses a data item stored in a contiguous manner in memory with data items assigned to neighboring lanes of execution of the vector processing circuit. In other words, the data items are stored in the same cache line of the memory. Other times, one or more of the data items used in a wavefront are not stored in a contiguous manner in memory with other data items assigned to neighboring lanes of execution of the vector processing circuit.

An example of the vector memory access instructions is a texture sample instruction used to read texture pixel data from memory, sample or filter the retrieved texture pixel data, and store the results in a specified range of vector registers of the vector register file. Another example of the vector memory access instructions is an image load instruction used to read pixel data from memory and store the retrieved data in a specified range of vector registers of the vector register file without prior modification. Another example of the vector memory access instructions is a raytracing instruction that retrieves data items from memory to store pixel data in vector registers of the vector register file and perform rending techniques on the retrieved data items to model lighting effects on the pixel data of the corresponding image.

Yet another example of vector memory access instructions is a vector stack access instruction that accesses temporary data. An example of the temporary data is stack data of a function call used by each wavefront that is generated based on the function call. Vector stack access instructions target data stored in the local memory using an address provided by the vector stack access instruction in place of using an address stored in the vector register file. In an implementation, local memory subsystem 200 uses execution pipeline 280 to process many types of vector memory access instruction. However, local memory subsystem 200 uses execution pipeline 290 to process vector stack access instructions. Execution pipeline 280 includes multiple complex pipeline stages supporting per-lane address offsets, tag address coalescing, gather and scatter circuitry to handle different execution lanes of a same vector processing circuit accessing data items concurrently from different cache lines, post processing circuitry to handle sign extending data, converting data between data formats, performing texture sampling and/or filtering, and so forth. Execution pipeline 290 does not include these multiple complex pipeline stages. Thus, execution pipeline 290 has a latency less than the latency of the execution pipeline 280.

When decoder 212 generates an indication specifying a received vector memory access instruction is not a vector stack access instruction, decoder 212 sends the vector memory access instruction to input buffer 214 of execution pipeline 280. Otherwise, decoder 212 sends the vector memory access instruction to input buffer 216 of execution pipeline 290. In some implementations, each of input buffers 214 and 216 is a first-in, first-out (FIFO) buffer using one of a variety of types of data storage circuitry. Tag coalescer 224 compares tag addresses of vector memory access instructions to generate an indication specifying whether one or more lanes of parallel execution of a vector processing circuit targets the same cache line. If so, tag coalescer 224 reduces the number of individual vector memory access requests sent to tag checker 226 and data cache 240. Execution pipeline 290 bypasses performing tag coalescing, since the temporary data of a vector stack accesses data stored in the same cache line. Therefore, execution pipeline 290 has a latency less than the latency of the execution pipeline 280.

Each of tag checkers 226 and 250 compares tag addresses of vector memory access instructions to tag addresses stored in tag array 222. Each of tag checkers 226 and 250 generates indications specifying cache hits or cache misses. Each of return queues 228 and 254 includes data storage circuitry to store vector memory access requests that miss in tag array 222. In various implementations, each of return queues 228 and 254 is a FIFO buffer. Corresponding miss requests are sent from return queues to data cache 260. Corresponding cache fill data are sent from data cache 260 or another lower-level memory of the cache memory subsystem to return queues 228 and 254. Typically, cache fill data for vector stack memory access instructions are found in data cache 260, whereas cache fill data for other types of vector memory access instructions are found in a lower-level memory with a larger access latency than the latency of data cache 260. By being stored in the separate return queue 254 of execution pipeline 290, the vector stack memory access instructions do not wait on longer latency vector memory access instructions stored in the return queue 228. For this further reason, execution pipeline 290 has a latency less than the latency of the execution pipeline 280.

Bank coalescer 230 of execution pipeline 280 generates indications specifying which cache banks of data cache 240 are targeted by received vector memory access requests. If multiple vector memory access requests target the same cache bank, then these vector memory access requests can be grouped together to reduce cache bank conflicts. Execution pipeline 290 bypasses performing bank coalescing, since the temporary data of a vector stack accesses data stored in the same cache bank. Therefore, execution pipeline 290 has a latency less than the latency of the execution pipeline 280. In addition, when cache hits occur in execution pipeline 290 for vector stack access instructions, the corresponding vector stack access instructions bypass return queue 254 and any bank coalescing circuitry to directly access data cache 240 via the direct signal route vector cache hit bypass 252.

Post access stages 270 includes multiple types of circuit blocks for execution pipeline 280 that are absent in execution pipeline 290. An example of the circuit block is the gather crossbar 272 that regroups vector memory access requests based on work items of a wavefront, rather than grouped based on accesses of the same cache line and the same cache bank. The circuit block sign extender 274 performs sign extension when necessary for retrieved data items used for work items of a wavefront. The circuit block texture sampler 276 performs sampling or filtering steps for retrieved texture pixel data. The circuit block data format converter 278 performs data conversion of data items used for work items of a wavefront. The data conversion changes the precision of the data items. Execution pipeline 290 bypasses the steps performed by the circuit blocks 272-278. For these further reasons, execution pipeline 290 has a latency less than the latency of the execution pipeline 280.

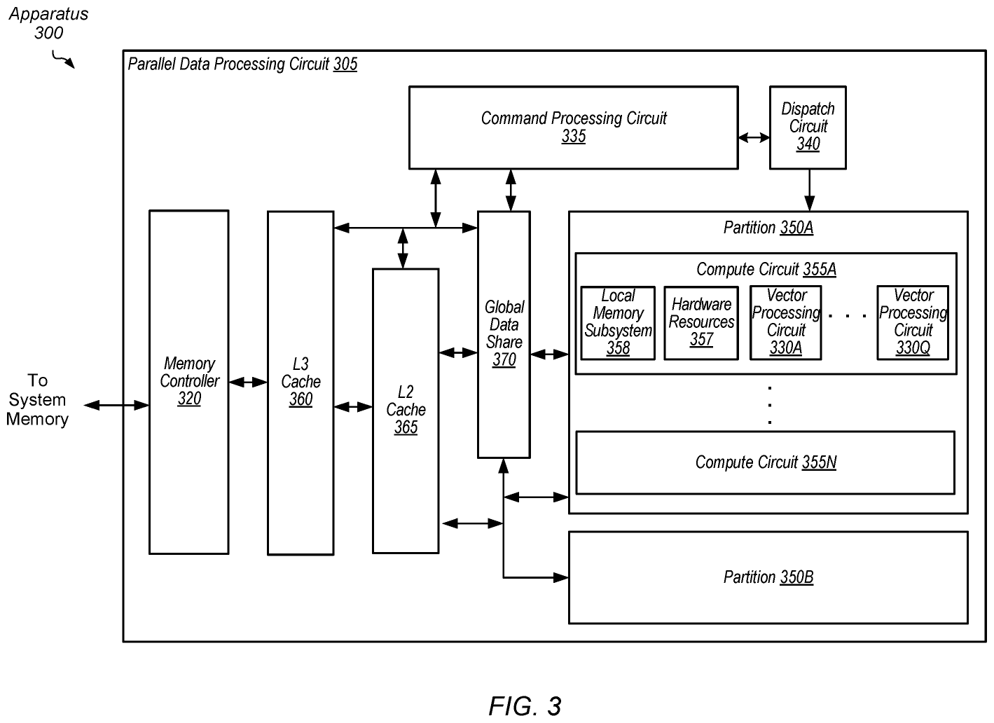

Turning now to FIG. 3, a block diagram is shown of an apparatus 300 that efficiently processes vector memory accesses on an integrated circuit. In one implementation, apparatus 300 includes parallel data processing circuit 305 with an interface to system memory. In an implementation, the parallel data processing circuit 305 is a graphics processing unit (GPU). In various implementations, apparatus 300 executes any of various types of highly parallel data applications. As part of executing an application, a host CPU (not shown) launches kernels to be executed by the parallel data processing circuit 305. The command processing circuit 335 receives kernels from the host CPU and determines when dispatch circuit 340 dispatches wavefronts of these kernels to the compute circuits 355A-355N.

Multiple processes of a highly parallel data application provide multiple kernels to be executed on the compute circuits 355A-355N. Each kernel corresponds to a function call of the highly parallel data application. The parallel data processing circuit 305 includes at least the command processing circuit (or command processor) 335, dispatch circuit 340, compute circuits 355A-355N, memory controller 320, global data share 370, level two (L2) cache 365, and level three (L3) cache 360. It should be understood that the components and connections shown for the parallel data processing circuit 305 are merely representative of one type processing circuit and does not preclude the use of other types of processing circuits for implementing the techniques presented herein. The apparatus 300 also includes other components which are not shown to avoid obscuring the figure. In other implementations, the parallel data processing circuit 305 includes other components, omits one or more of the illustrated components, has multiple instances of a component even if only one instance is shown in the apparatus 300, and/or is organized in other suitable manners. Also, each connection shown in the apparatus 300 is representative of any number of connections between components. Additionally, other connections can exist between components even if these connections are not explicitly shown in apparatus 300.

In an implementation, the memory controller 320 directly communicates with each of the partitions 350A-350B and includes circuitry for supporting communication protocols and queues for storing requests and responses. Threads within wavefronts executing on compute circuits 355A-355N read data from and write data to a local memory in local memory subsystem 358, vector general-purpose registers, scalar general-purpose registers, and when present, the global data share 370, the L2 cache 365, and the L3 cache 360. When present, it is noted that L2 cache 365 can include separate structures for data and instruction caches. In various implementations, a level one (L1) cache is provided in each of the multiple compute circuits 355A-355N such as in the local memory subsystem 358. It is also noted that local memory in local memory subsystem 358, global data share 370, L2 cache 365, L3 cache 360, memory controller 320, and system memory can collectively be referred to herein as a “cache memory subsystem”.

In various implementations, the circuitry of partition 350B is a replicated instantiation of the circuitry of partition 350A. In some implementations, each of the partitions 350A-350B is a chiplet. As used herein, a “chiplet” is also referred to as an “intellectual property block” (or IP block). However, a “chiplet” is a semiconductor die (or die) fabricated separately from other dies, and then interconnected with these other dies in a single integrated circuit in the MCM. On a single silicon wafer, only multiple chiplets are fabricated as multiple instantiated copies of particular integrated circuitry, rather than fabricated with other functional blocks that do not use an instantiated copy of the particular integrated circuitry. For example, the chiplets are not fabricated on a silicon wafer with various other functional blocks and processors on a larger semiconductor die such as an SoC. A first silicon wafer (or first wafer) is fabricated with multiple instantiated copies of integrated circuitry a first chiplet, and this first wafer is diced using laser cutting techniques to separate the multiple copies of the first chiplet. A second silicon wafer (or second wafer) is fabricated with multiple instantiated copies of integrated circuitry of a second chiplet, and this second wafer is diced using laser cutting techniques to separate the multiple copies of the second chiplet.

Each of the multiple compute circuits 355A-355N includes vector processing circuits 330A-330Q, each with circuitry of multiple parallel computational lanes of simultaneous execution. These parallel computational lanes operate in lockstep. In various implementations, the data flow within each of the lanes is pipelined. Pipeline registers are used for storing intermediate results and circuitry for arithmetic logic units (ALUs) perform integer arithmetic, floating-point arithmetic, Boolean logic operations, branch condition comparisons and so forth. These components are not shown for ease of illustration. Each of the ALUs within a given row across the lanes includes the same circuitry and functionality, and operates on the same instruction, but different data, such as a different data item, associated with a different thread. In various implementations, each of the vector ALUs of vector processing circuits 330A-330Q has the same functionality as vector ALU 160 (of FIG. 1).

In addition to the vector processing circuits 330A-330Q, the compute circuit 355A also includes the hardware resources 357. The hardware resources 357 include at least an assigned number of vector general-purpose registers (VGPRs) per thread, and an assigned number of scalar general-purpose registers (SGPRs) per wavefront. Local memory subsystem 358 includes one of multiple types of local memory such as an assigned data storage space of a local data store per workgroup. In various implementations, local memory subsystem 358 has the same functionality as local memory subsystem 180 (of FIG. 1) and local memory subsystem 200 (of FIG. 2). Each of the compute circuits 355A-355N receives wavefronts from the dispatch circuit 340 and stores the received wavefronts in a corresponding local dispatch circuit (not shown). A local scheduler within the compute circuits 355A-355N schedules these wavefronts to be dispatched from the local dispatch circuits to the vector processing circuits 330A-330Q.

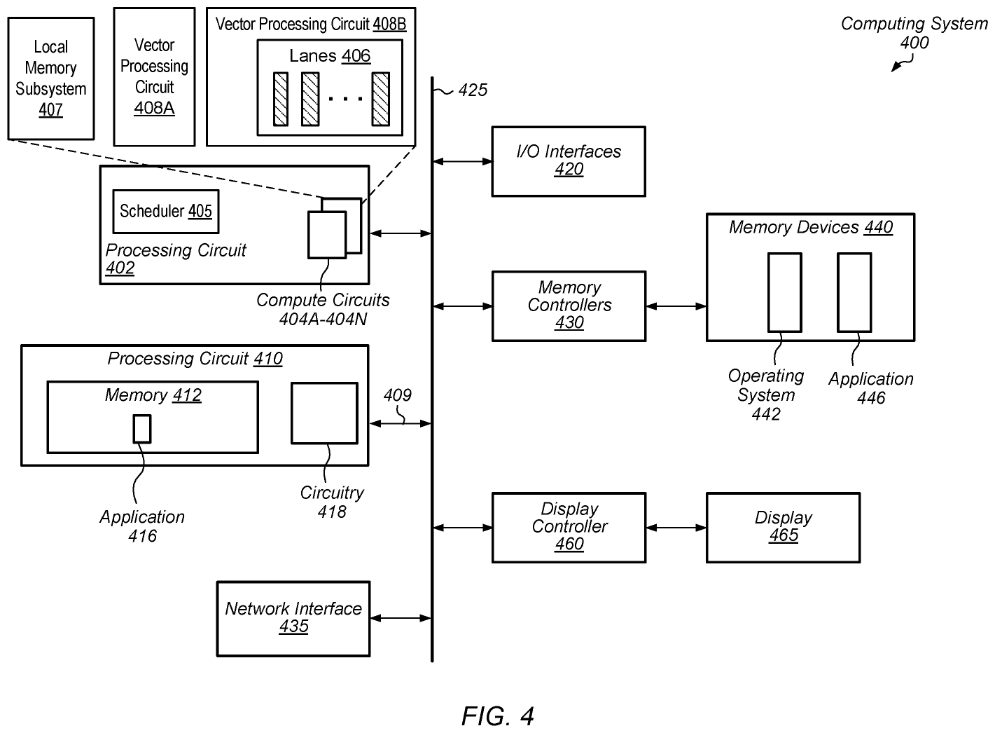

Turning now to FIG. 4, a generalized diagram is shown of a computing system 400 that efficiently processes vector memory accesses on an integrated circuit. In an implementation, the computing system 400 includes at least processing circuits 402 and 410, input/output (I/O) interfaces 420, bus 425, network interface 435, memory controllers 430, memory devices 440, display controller 460, and display 465. In other implementations, computing system 400 includes other components and/or computing system 400 is arranged differently. For example, power management circuitry, and phased locked loops (PLLs) or other clock generating circuitry are not shown for ease of illustration. In various implementations, the components of the computing system 400 are on the same die such as a system-on-a-chip (SOC). In other implementations, the components are individual dies in a system-in-package (SiP) or a multi-chip module (MCM). A variety of computing devices use the computing system 400 such as a desktop computer, a laptop computer, a server computer, a tablet computer, a smartphone, a gaming device, a smartwatch, and so on.

Processing circuits 402 and 410 are representative of any number of processing circuits which are included in computing system 400. In an implementation, processing circuit 410 is a general-purpose central processing unit (CPU). In one implementation, processing circuit 402 is a parallel data processing circuit with a highly parallel data microarchitecture, such as a GPU. The processing circuit 402 can be a discrete device, such as a dedicated GPU (dGPU), or the processing circuit 402 can be integrated (an iGPU) in the same package as another processing circuit. Other parallel data processing circuits that can be included in computing system 400 include digital signal processing circuits (DSPs), field programmable gate arrays (FPGAs), application specific integrated circuits (ASICs), and so forth.

In various implementations, the processing circuit 402 includes multiple, replicated compute circuits 404A-404N, each including similar circuitry and components such as the vector processing circuits 408A-408B, the cache 407, and hardware resources (not shown). Vector processing circuit 408A includes replicated circuitry of the circuitry of the vector processing circuit 408A. Although two vector processing circuits are shown, in other implementations, another number of vector processing circuits is used based on design requirements. As shown, vector processing circuit 408B includes multiple, parallel computational lanes 406. In various implementations, each of the multiple, parallel computational lanes 406 has the functionality of lanes 120A-120C (of FIG. 1). Therefore, each of compute circuits 404A-404N has the same functionality as compute circuit 100 (of FIG. 1) and compute circuits 355A-355N (of FIG. 3). In various implementations, local memory subsystem 407 has the functionality of local memory subsystem 180 (of FIG. 1) and local memory subsystem 200 (of FIG. 2).

The hardware of scheduler 405 assigns wavefronts to be dispatched to the compute circuits 404A-404N. In an implementation, scheduler 405 is a command processing circuit of a GPU. In some implementations, the application 446 stored on the memory devices 440 and its copy (application 416) stored on the memory 412 are a highly parallel data application that includes particular function calls using an API to allow the developer to insert a request in the highly parallel data application for launching wavefronts of a kernel (function call). In an implementation, this kernel launch request is a C++ object, and it is converted by circuitry 418 of the processing circuit 410 to a command.

In some implementations, application 446 is a highly parallel data application that provides multiple kernels to be executed on the compute circuits 404A-404N. The high parallelism offered by the hardware of the compute circuits 404A-404N is used for real-time data processing. Examples of real-time data processing are rendering multiple pixels, image blending, pixel shading, vertex shading, and geometry shading. In such cases, each of the data items of a wavefront is a pixel of an image. The compute circuits 404A-404N can also be used to execute other threads that require operating simultaneously with a relatively high number of different data elements (or data items). Examples of these threads are threads for scientific, medical, finance and encryption/decryption computations.

Memory 412 represents a local hierarchical cache memory subsystem. Memory 412 stores source data, intermediate results data, results data, and copies of data and instructions stored in memory devices 440. Processing circuit 410 is coupled to bus 425 via interface 409. Processing circuit 410 receives, via interface 409, copies of various data and instructions, such as the operating system 442, one or more device drivers, one or more applications such as application 446, and/or other data and instructions. The processing circuit 410 retrieves a copy of the application 446 from the memory devices 440, and the processing circuit 410 stores this copy as application 416 in memory 412.

In some implementations, computing system 400 utilizes a communication fabric (“fabric”), rather than the bus 425, for transferring requests, responses, and messages between the processing circuits 402 and 410, the I/O interfaces 420, the memory controllers 430, the network interface 435, and the display controller 450. When messages include requests for obtaining targeted data, the circuitry of interfaces within the components of computing system 400 translates target addresses of requested data. In some implementations, the bus 425, or a fabric, includes circuitry for supporting communication, data transmission, network protocols, address formats, interface signals and synchronous/asynchronous clock domain usage for routing data.

Memory controllers 430 are representative of any number and type of memory controllers accessible by processing circuits 402 and 410. While memory controllers 430 are shown as being separate from processing circuits 402 and 410, it should be understood that this merely represents one possible implementation. In other implementations, one of memory controllers 430 is embedded within one or more of processing circuits 402 and 410 or it is located on the same semiconductor die as one or more of processing circuits 402 and 410. Memory controllers 430 are coupled to any number and type of memory devices 440.

Memory devices 440 are representative of any number and type of memory devices. For example, the type of memory in memory devices 440 includes Dynamic Random Access Memory (DRAM), Static Random Access Memory (SRAM), NAND Flash memory, NOR flash memory, Ferroelectric Random Access Memory (FeRAM), or otherwise. Memory devices 440 store at least instructions of an operating system 442, one or more device drivers, and application 446. In some implementations, application 446 is a highly parallel data application such as a video graphics application, a shader application, or other. Copies of these instructions can be stored in a memory or cache device local to processing circuit 410 and/or processing circuit 402.

I/O interfaces 420 are representative of any number and type of I/O interfaces (e.g., peripheral component interconnect (PCI) bus, PCI-Extended (PCI-X), PCIE (PCI Express) bus, gigabit Ethernet (GBE) bus, universal serial bus (USB). Various types of peripheral devices (not shown) are coupled to I/O interfaces 420. Such peripheral devices include (but are not limited to) displays, keyboards, mice, printers, scanners, joysticks or other types of game controllers, media recording devices, external storage devices, and so forth. Network interface 135 receives and sends network messages across a network.

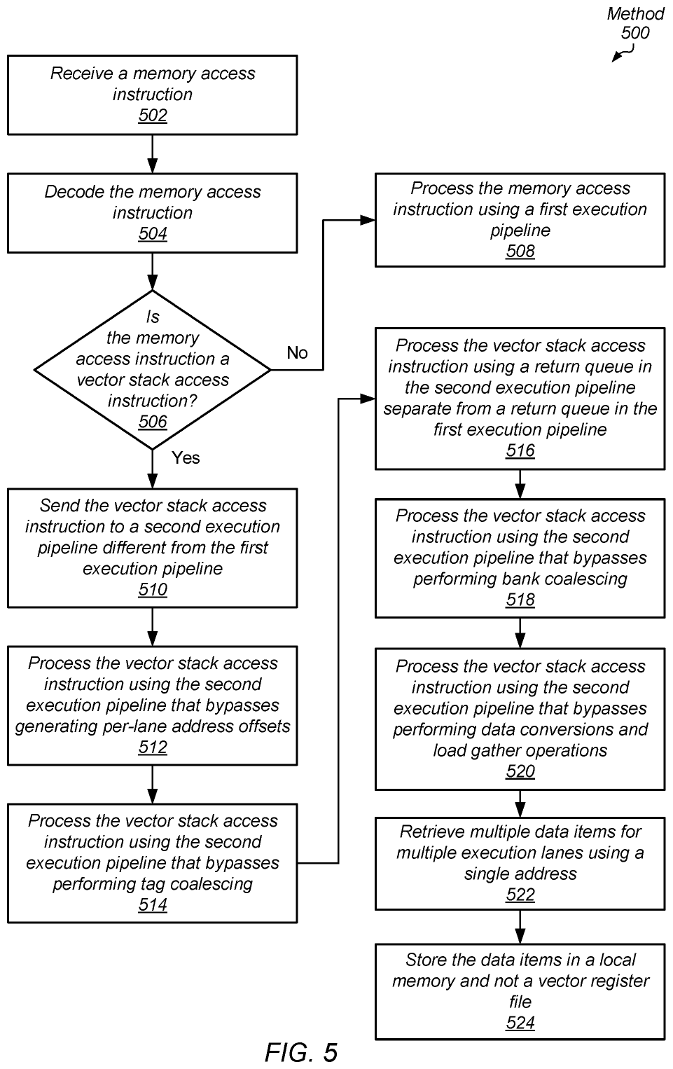

Referring to FIG. 5, a generalized diagram is shown of a method 500 for efficiently processing vector memory accesses on an integrated circuit. For purposes of discussion, the steps in this implementation are shown in sequential order. However, in other implementations some steps occur in a different order than shown, some steps are performed concurrently, some steps are combined with other steps, and some steps are absent.

Circuitry receives a vector memory access instruction (block 502). In some implementations, the circuitry is within a compute circuit of multiple compute circuits of a parallel data processing circuit with a highly parallel data microarchitecture. A general-purpose processing circuit translates instructions of an application to commands and stores the commands in a ring buffer. The parallel data processing circuit reads the commands from the ring buffer and assigns the commands to the multiple compute circuits. The commands can be treated as instructions with opcodes and operand identifiers. The parallel data processing circuit includes multiple, replicated compute circuits, each with the circuitry of multiple lanes of execution. Each compute circuit executes one or more wavefronts. In various implementations, the parallel data processing circuit executes a variety of parallel data instructions such as vector memory access instructions.

Vector memory access instructions access multiple data items, each used for a respective work item of a wavefront. The wavefront is executed on a vector processing circuit (a SIMD circuit), and each lane of execution of the vector processing circuit within a corresponding compute circuit executes a respective thread or work item of the wavefront. Multiple wavefronts are assigned to multiple compute circuits, each with one or more vector processing circuits. At times, each work item of a wavefront accesses a data item stored in a contiguous manner in memory with data items assigned to neighboring lanes of execution of the vector processing circuit. In other words, the data items are stored in the same cache line of the memory. Other times, one or more of the data items used in a wavefront are not stored in a contiguous manner in memory with other data items assigned to neighboring lanes of execution of the vector processing circuit.

The parallel data processing circuit supports execution of a variety of types of vector memory access instructions. An example of the vector memory access instructions is a texture sample instruction used to read texture pixel data from memory, sample or filter the retrieved texture pixel data, and store the results in a specified range of vector registers of the vector register file. Another example of the vector memory access instructions is an image load instruction used to read pixel data from memory and store the retrieved data in a specified range of vector registers of the vector register file without prior modification. Another example of the vector memory access instructions is a raytracing instruction that retrieves data items from memory to store pixel data in vector registers of the vector register file and perform rending techniques on the retrieved data items to model lighting effects on the pixel data of the corresponding image.

Yet another example of the vector memory access instructions is a vector stack memory access instruction. The parallel data processing circuit includes a memory used to store temporary data. An example of the temporary data is stack data of a function call used by each wavefront that is generated based on the function call. In some implementations, the memory is a local memory of the parallel data processing circuit such as dedicated memory that is not shared with another processing circuit. In an implementation, the local memory is a portion of video memory used to store video frame data. In other implementations, the local memory is a local cache of a compute circuit used to store the temporary data. Vector stack memory access instructions access data stored in the local memory, rather than stored in the vector register file.

The circuitry of the compute circuit decodes the vector memory access instruction (block 504). If the instruction is not the vector stack memory access instruction (“no” branch of the conditional block 506), then the circuitry processes the memory instruction by executing operations indicated by the vector memory access instruction. The corresponding compute circuit performs the operations based at least upon the opcode of the vector memory access instruction (block 508). In an implementation, the compute circuit uses a first execution pipeline of the local memory subsystem to process the vector memory access instruction. The first execution pipeline includes multiple complex pipeline stages supporting per-lane address offsets, tag address coalescing, gather and scatter circuitry to handle different execution lanes of a same vector processing circuit accessing data items concurrently from different cache lines, post processing circuitry to handle sign extending data, converting data between data formats, performing texture sampling and/or filtering, and so forth.

If the instruction is the vector stack memory access instruction (“yes” branch of the conditional block 506), then the compute circuit sends the vector stack access instruction to a second execution pipeline different from the first execution pipeline (block 510). The compute circuit processes the vector stack access instruction using the second execution pipeline that prevents generating per-lane address offsets (block 512). The compute circuit processes the vector stack access instruction using the second execution pipeline that bypasses processing by tag coalescing circuitry (block 514). The compute circuit processes the vector stack access instruction using a return queue in the second execution pipeline separate from a return queue in the first execution pipeline (block 516).

The compute circuit processes the vector stack access instruction using the second execution pipeline that bypasses performing bank coalescing (block 518). The compute circuit processes the vector stack access instruction using the second execution pipeline that bypasses performing data conversions and load gather operations (block 520). The compute circuit retrieves multiple data items for multiple execution lanes using a single address (block 522). The compute circuit stores the data items in a local memory and not a vector register file (block 524). In other words, the second execution pipeline does not include many circuit blocks used in the first execution pipeline. For example, the second execution pipeline does not include multiple complex pipeline stages supporting per-lane address offsets, tag address coalescing, gather and scatter circuitry to handle different execution lanes of a same vector processing circuit accessing data items concurrently from different cache lines, post processing circuitry to handle sign extending data, converting data between data formats, performing texture sampling and/or filtering, and so forth. The second execution pipeline bypasses these circuit blocks and the corresponding functionality. Therefore, processing the vector stack memory access instructions by using the second execution pipeline provides a lower latency compared with processing other types of vector memory access instructions using the first execution pipeline.

It is noted that one or more of the above-described implementations include software. In such implementations, the program instructions that implement the methods and/or mechanisms are conveyed or stored on a computer readable medium. Numerous types of media which are configured to store program instructions are available and include hard disks, floppy disks, CD-ROM, DVD, flash memory, Programmable ROMs (PROM), random access memory (RAM), and various other forms of volatile or non-volatile storage. Generally speaking, a computer accessible storage medium includes any storage media accessible by a computer during use to provide instructions and/or data to the computer. For example, a computer accessible storage medium includes storage media such as magnetic or optical media, e.g., disk (fixed or removable), tape, CD-ROM, or DVD-ROM, CD-R, CD-RW, DVD-R, DVD-RW, or Blu-Ray. Storage media further includes volatile or non-volatile memory media such as RAM (e.g., synchronous dynamic RAM (SDRAM), double data rate (DDR, DDR2, DDR3, etc.) SDRAM, low-power DDR (LPDDR2, etc.) SDRAM, Rambus DRAM (RDRAM), static RAM (SRAM), etc.), ROM, Flash memory, non-volatile memory (e.g., Flash memory) accessible via a peripheral interface such as the Universal Serial Bus (USB) interface, etc. Storage media includes microelectromechanical systems (MEMS), as well as storage media accessible via a communication medium such as a network and/or a wireless link.

Additionally, in various implementations, program instructions include behavioral-level descriptions or register-transfer level (RTL) descriptions of the hardware functionality in a high-level programming language such as C, or a design language (HDL) such as Verilog, VHDL, or database format such as GDS II stream format (GDSII). In some cases, the description is read by a synthesis tool, which synthesizes the description to produce a netlist including a list of gates from a synthesis library. The netlist includes a set of gates, which also represent the functionality of the hardware including the system. The netlist is then placed and routed to produce a data set describing geometric shapes to be applied to masks. The masks are then used in various semiconductor fabrication steps to produce a semiconductor circuit or circuits corresponding to the system. Alternatively, the instructions on the computer accessible storage medium are the netlist (with or without the synthesis library) or the data set, as desired. Additionally, the instructions are utilized for purposes of emulation by a hardware based type emulator from such vendors as Cadence®, EVE®, and Mentor Graphics®.

Although the implementations above have been described in considerable detail, numerous variations and modifications will become apparent to those skilled in the art once the above disclosure is fully appreciated. It is intended that the following claims be interpreted to embrace all such variations and modifications.

What is claimed is:

1. An apparatus comprising:
circuitry configured to:
receive a first vector memory access instruction and a second vector memory access instruction;
send the first vector memory access instruction to a first execution pipeline, responsive to the first vector memory access instruction not being a vector stack access instruction; and
send the second vector memory access instruction to a second execution pipeline different from the first execution pipeline, responsive to the second vector memory access instruction being a vector stack access instruction, wherein the second execution pipeline has a lower access latency than a latency of the first execution pipeline.

2. The apparatus as recited in claim 1, further comprising a local memory and a vector register file, wherein the circuitry is further configured to access data targeted by the vector stack access instruction in the local memory using an address provided by the vector stack access instruction in place of using an address stored in the vector register file.

3. The apparatus as recited in claim 2, wherein:
the first execution pipeline comprises circuitry configured to generate per-lane address offsets for the first vector memory access instruction; and
the second execution pipeline bypasses generating per-lane address offsets for the second vector memory access instruction.

4. The apparatus as recited in claim 2, wherein:
the first execution pipeline comprises circuitry configured to perform tag coalescing for the first vector memory access instruction; and
the second execution pipeline bypasses performing tag coalescing for the second vector memory access instruction.

5. The apparatus as recited in claim 2, wherein:
the first execution pipeline comprises circuitry configured to perform cache bank coalescing for the first vector memory access instruction; and
the second execution pipeline bypasses performing cache bank coalescing for the second vector memory access instruction.

6. The apparatus as recited in claim 2, wherein:
the first execution pipeline comprises circuitry configured to store data retrieved from lower-level memory into a first return queue prior to accessing the local memory; and
the second execution pipeline comprises circuitry configured to store data retrieved from lower-level memory into a second return queue different from the first return queue prior to accessing the local memory.

7. The apparatus as recited in claim 6, wherein the second execution pipeline further comprises circuitry configured to bypass the second return queue responsive to a cache hit.

8. A method, comprising:
generating vector memory access instructions by a plurality of execution circuits;
storing data by a local memory of a local memory subsystem;
receiving, from the plurality of execution circuits by circuitry of the local memory subsystem, a first vector memory access instruction and a second vector memory access instruction;
sending, by the circuitry, the first vector memory access instruction to a first execution pipeline, responsive to the first vector memory access instruction is not a vector stack access instruction; and
sending, by the circuitry, the second vector memory access instruction to a second execution pipeline different from the first execution pipeline, responsive to the second vector memory access instruction is a vector stack access instruction, wherein the second execution pipeline has a latency less than a latency of the first execution pipeline.

9. The method as recited in claim 8, further comprising accessing, by the circuitry, data targeted by the vector stack access instruction in the local memory using an address provided by the vector stack access instruction in place of using an address stored in a vector register file.

10. The method as recited in claim 9, further comprising:
generating, by the first execution pipeline, per-lane address offsets for the first vector memory access instruction; and
bypassing, by the second execution pipeline, generating per-lane address offsets for the second vector memory access instruction.

11. The method as recited in claim 9, further comprising:
performing, by the first execution pipeline, tag coalescing for the first vector memory access instruction; and
bypassing, by the second execution pipeline, performing tag coalescing for the second vector memory access instruction.

12. The method as recited in claim 9, further comprising:
performing, by the first execution pipeline, cache bank coalescing for the first vector memory access instruction; and
bypassing, by the second execution pipeline, performing cache bank coalescing for the second vector memory access instruction.

13. The method as recited in claim 9, wherein prior to accessing the local memory, the method further comprises:
storing, by the first execution pipeline, in a first return queue, vector memory access instructions that are not vector stack access instructions after accesses of a tag array for the vector memory access instructions; and
storing, by the second execution pipeline, in a second return queue different from the first return queue, vector stack access instructions responsive to misses in the tag array caused by accesses of the tag array for the vector stack access instructions.

14. The method as recited in claim 10, further comprising:
performing, by the first execution pipeline, data format conversion of data targeted by the first vector memory access instruction; and
bypassing, by the second execution pipeline, performing data format conversion of data targeted by the second vector memory access instruction.

15. A computing system comprising:
a plurality of execution circuits, each comprising circuitry configured to generate vector memory access instructions; and
a local memory subsystem comprising:
a local memory configured to store data; and
circuitry configured to:
receive, from the plurality of execution circuits, a first vector memory access instruction and a second vector memory access instruction;
send the first vector memory access instruction to a first execution pipeline, responsive to the first vector memory access instruction is not a vector stack access instruction; and
send the second vector memory access instruction to a second execution pipeline different from the first execution pipeline, responsive to the second vector memory access instruction is a vector stack access instruction, wherein the second execution pipeline has a latency less than a latency of the first execution pipeline.

16. The computing system as recited in claim 15, wherein the circuitry is further configured to access data targeted by the vector stack access instruction in the local memory using an address provided by the vector stack access instruction in place of using an address stored in a vector register file.

17. The computing system as recited in claim 16, wherein:
the first execution pipeline comprises circuitry configured to generate per-lane address offsets for the first vector memory access instruction; and
the second execution pipeline bypasses generating per-lane address offsets for the second vector memory access instruction.

18. The computing system as recited in claim 16, wherein:
the first execution pipeline comprises circuitry configured to perform tag coalescing for the first vector memory access instruction; and
the second execution pipeline bypasses performing tag coalescing for the second vector memory access instruction.

19. The computing system as recited in claim 16, wherein:
the first execution pipeline comprises circuitry configured to perform cache bank coalescing for the first vector memory access instruction; and
the second execution pipeline bypasses performing cache bank coalescing for the second vector memory access instruction.

20. The computing system as recited in claim 16, wherein:
the first execution pipeline comprises circuitry configured to perform data format conversion of data targeted by the first vector memory access instruction; and
the second execution pipeline bypasses performing data format conversion of data targeted by the second vector memory access instruction.
